(19) United States
(12) Patent Application Publication
(10) Pub. No.: US 2026/0105385 A1
(43) Pub. Date: Apr. 16, 2026

(54) UTILIZING INTENT MODELS AND PRE-REQUEST, MULTI-REQUESTOR DEVICE INTERFACES OF MOBILE PROVIDER DEVICES TO GENERATE PRE-REQUEST TRANSPORTATION MATCHES

(71) Applicant: Lyft, Inc., San Francisco, CA (US)

(72) Inventors: Hao Zuo, Brooklyn, NY (US); Timothy Philip Holland, New York, NY (US); Titouan Alexandre Kevin Jehl, Berkeley, CA (US); James Owen Koch, Pittsburg, PA (US); Angela Lam, Sunnyvale, CA (US); Benjamin Edward Norquist, San Francisco, CA (US)

(21) Appl. No.: 18/916,449

(22) Filed: Oct. 15, 2024

(51) Int. Cl. G06Q 10/02; G06Q 50/47

(52) U.S. Cl. CPC G06Q 10/02; G06Q 50/47

(57) ABSTRACT

The present disclosure relates to systems, non-transitory computer-readable media, and methods for utilizing intent models and pre-request, multi-requestor device interfaces of mobile provider devices to generate pre-request transportation matches between mobile provider devices and mobile requestor devices. In particular, in one or more embodiments, the disclosed systems can utilize an intent model to detect a pre-transportation request intent from user interactions with an application of a requestor device. In some cases, based on detecting the pre-transportation request intent, the disclosed systems can provide a multi-requestor device interface on a provider device with a pre-transportation request indicator corresponding to the requestor device along with post-transportation request indicators for other requestor devices. In some implementations, in response to detecting a selection of the pre-transportation request indicator, the disclosed systems can provide for display on the requestor device, a pre-request transportation match corresponding to the provider device.

### BACKGROUND

Recent years have seen significant developments in on-demand transportation systems that utilize mobile devices to coordinate across computer networks. Indeed, the proliferation of web and mobile applications has enabled requesting devices to utilize on-demand ride-sharing systems to identify matches between provider devices and requestor devices and coordinate across computer networks to initiate transportation from one geographic location to another. For instance, conventional transportation network systems can determine the geographic locations of provider devices and requestor devices, generate digital matches between provider devices and requestor devices, and further track, analyze, and manage pick-up, transportation, and drop-off routines through digital transmissions across computer networks. Although on-demand transportation matching systems can identify requestor devices, select provider devices, dispatch provider devices, and dynamically match requestor devices and provider devices, such systems suffer from a number of technical problems, particularly in the efficiency, flexibility, and precision of implementing computer systems.

For example, conventional systems rigidly and inefficiently generate transportation matches between provider devices and requestor devices across computer networks. To illustrate, conventional systems utilize a rigid workflow where the system (1) provides a user interface to a requestor device for initiating a transportation request, (2) receives a selection of a transportation request and corresponding details, (3) initiates a transportation matching algorithm to select a provider device, (4) provides a user interface with a proposed transportation match to a provider device, (5) receives acceptance of the transportation match from the provider device, and (6) provides the transportation match to the provider device. This approach is not only rigid but also inefficient. For example, conventional systems require requester devices to provide various user interactions to initiate a transportation request then wait for various interactions with requester devices before identifying pertinent information regarding a transportation match.

Similarly, provider devices receive rigid user interfaces with limited elements (e.g., a single transportation option). This approach often leads provider devices to utilize multiple different transportation matching applications to identify additional potential transportation matches. This not only leads to excessive processing resources on the provider device but also duplicative computing resources at implementing servers in providing transportation matches serially to different provider devices until a provider device accepts a particular transportation request.

Conventional systems are also imprecise. Indeed, as mentioned above, conventional systems provide a transportation request user interface to requestor devices with estimated information for potential transportation matches. However, this potential transportation request information is often imprecise because no transportation match has actually been generated. Thus, for example, conventional systems often inaccurately provide an estimated pickup time for a requester device. Upon generating a transportation match, the estimated pickup time is often updated with a modified pickup time (that can differ substantially from the initial estimate). This imprecision often leads requester devices to cancel transportation requests, initiate additional queries, impose additional bandwidth requirements, and/or navigate to alternative applications for additional transportation matches. This further undermines the efficiency of conventional systems.

These along with additional problems and issues exist with regard to conventional transportation matching systems.

### BRIEF SUMMARY

This disclosure describes one or more embodiments of methods, non-transitory computer-readable media, and systems for utilizing intent models and pre-request, multi-requestor device interfaces of mobile provider devices to generate pre-request transportation matches between mobile provider devices and mobile requestor devices. For instance, in one or more embodiments, the disclosed systems can detect a pre-transportation request intent from a mobile requestor device by utilizing an intent model to analyze user interactions with an application of the mobile requestor device. Based on detecting the pre-transportation request intent, the disclosed systems can provide for display via a multi-requestor device user interface of a mobile provider device, a pre-transportation request indicator reflecting the pre-transportation request intent from the mobile requestor device along with post-transportation request indicators corresponding to additional mobile requestor devices. Further, the disclosed systems can detect a selection of the pre-transportation request indicator via the multi-requestor device user interface, and in response can provide for display, a pre-request transportation match on the mobile requestor device that corresponds to the mobile provider device. In this manner, the disclosed systems can efficiently and intelligently generate instant transportation matches between mobile provider devices and mobile requestor devices across a transportation network.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a pre-request matching system can operate in accordance with one or more embodiments.

FIG. 2 illustrates an overview of a pre-request matching system generating and providing for display a pre-request transportation match on a mobile requestor device in accordance with one or more embodiments.

FIG. 3 illustrates a pre-request matching system utilizing a sensitivity model to generate a predicted time of arrival sensitivity and/or a transportation value sensitivity for the mobile requestor device in accordance with one or more embodiments.

FIG. 4 illustrates a pre-request matching system providing for display via the multi-requestor device user interface, a pre-transportation request indicator based on extracting a selection pattern of transportation service requests from the mobile requestor device in accordance with one or more embodiments.

FIG. 5 illustrates, a pre-request matching system detecting a pre-transportation request intent from a mobile requestor device in accordance with one or more embodiments.

FIG. 6 illustrates an exemplary graphical user interface of a multi-requestor device user interface within a pre-transportation request indicators and post-transportation request indicators on a mobile provider device in accordance with one or more embodiments.

FIG. 7 illustrates an exemplary graphical user interface of a mobile requestor device with a pre-request transportation match in accordance with one or more embodiments.

FIG. 8 illustrates a pre-request matching system providing a pre-request transportation match display threshold via the mobile provider device in accordance with one or more embodiments.

FIG. 9 illustrates the pre-request matching system utilizing a differentiation model to differentiate between a pre-request transportation match and potential transportation matches in accordance with one or more embodiments.

FIG. 10 illustrates a flowchart of a series of acts for generating a pre-request transportation match in accordance with one or more embodiments.

FIG. 11 illustrates a block diagram of an example computing device for implementing one or more embodiments.

FIG. 12 illustrates a block diagram of an example pre-request matching system in accordance with one or more embodiments.

### DETAILED DESCRIPTION

This disclosure describes one or more embodiments of a pre-request matching system that utilizes intent models and pre-request, multi-requestor device interfaces of mobile provider devices to generate instant transportation matches between mobile provider devices and mobile requestor devices efficiently and quickly. For example, in one or more embodiments, the pre-request matching system can utilize an intent model in combination with a sensitivity model for mobile requestor devices and mobile provider devices to dynamically and efficiently generate instant transportation matches. In particular, the disclosed systems can analyze user interactions with an application of the mobile requestor device utilizing an intent model to detect a pre-transportation request intent from the mobile requestor device. Upon detecting the pre-transportation request intent, the pre-request matching system can provide for display a pre-transportation request indicator on a multi-requestor device user interface of a mobile provider device. In one or more cases, the multi-requestor device user interface can include post-transportation request indicators corresponding to additional mobile requestor devices along with the pre-transportation request indicator corresponding to the mobile requestor device. In response to detecting a selection of the pre-transportation request indicator from the mobile requestor device, the pre-request matching system can provide for display a pre-request transportation match on the mobile requestor device.

As just indicated, the pre-request matching system can provide a pre-request transportation match for display on mobile requestor devices. In some cases, the pre-request matching system can intelligently determine whether to surface the pre-request transportation match on mobile requestor devices based on analyzing user interactions with an application of a mobile requestor device, predicted time of arrival sensitivities, and/or transportation value sensitivities. More specifically, the pre-request matching system can detect the pre-transportation request intent from the mobile requestor device by analyzing one or more user interactions with the application on the mobile requestor device. For example, the pre-request matching system can detect a selection, input, and/or navigation through the application (e.g., transportation matching application). Moreover, based on the interactions or navigation with the transportation service application and/or historical data indicating predicted time of arrival sensitivities and/or transportation value sensitivities for the mobile requestor device, the pre-request matching system can identify and surface the pre-transportation request intent from the mobile requestor device to a provider device.

Indeed, in one or more embodiments, upon detecting the pre-transportation request intent from the mobile requestor device, the pre-request matching system can provide for display a multi-requestor device user interface on a mobile provider device that includes a pre-transportation request indicator corresponding to the mobile requestor device. Moreover, the multi-requestor device user interface can also include post-transportation request indicators corresponding to additional mobile requestor devices that submitted transportation requests. Indeed, in one or more embodiments, the pre-request matching system can surface the pre-transportation request indicator and post-transportation request indicators together to the mobile provider device. In some embodiments, the pre-transportation request indicator can indicate a modified (or elevated) transportation service value corresponding to a pre-request transportation match with the mobile requestor device.

In one or more implementations, the pre-request matching system can detect a selection of the pre-transportation request indicator from the mobile provider device, and in response, generate a pre-request transportation match between the mobile provider device and the mobile requestor device, which if selected, will lead to an instant transportation match between the mobile provider device and the mobile requestor device. In some cases, the pre-request matching system can provide for display on the mobile requestor device, the pre-request transportation match corresponding to the mobile provider device and can include a premium transportation service value, information about the vehicle associated with the mobile provider device, and/or pre-request transportation match display threshold corresponding to the pre-request transportation match.

As suggested above, the pre-request matching system provides several technical improvements or advantages over conventional systems. For instance, the pre-request matching system can improve and increase the flexibility and efficiency of generating transportation matches. Unlike some conventional systems that utilize a rigid workflow, the pre-request matching system can surface instant matches that reflect actual matched provider device information by providing multi-requestor device interfaces to mobile provider devices to generate pre-request transportation matches. Indeed, the pre-request matching system can utilize an intent model together with a multi-requestor device interface of a provider device to generate a transportation match between a mobile requestor device and mobile provider device even before the mobile requestor device submits a request. This approach provides significantly improved functionality and flexibility that was not previously available via computing devices implementing transportation matching systems.

In addition, the pre-request matching system significantly improves efficiency of implementing computing devices and user interfaces of requestor devices and provider devices. As an initial matter, the pre-request matching system significantly improves speed and reduces latency in generating transportation matches by intelligently generating pre-request transportation matches (before a requester device initiates a transportation request). For example, in one embodiment, the pre-request matching system can utilize an intent model to detect an intent (e.g. pre-transportation request intent) from the mobile requestor device to submit a transportation request in the future. Moreover, in some cases, the pre-request matching system can identify a mobile provider device nearby the location of the mobile requestor device. Based on detecting the pre-transportation request intent from the mobile requestor device, the pre-request matching system can quickly generate and surface a pre-transportation request indicator corresponding to the mobile requestor device on the mobile provider device. Upon detecting a selection of the pre-transportation request indicator from the mobile provider device, the pre-request matching system can generate a pre-request transportation match. Thus, the pre-request matching system can flexibly provide pre-request transportation options to requestor devices and additional options to provider devices through an improved workflow across various devices connected via a common computer network.

The pre-request matching system can also improve efficiency and reduce system bandwidth by utilizing a sensitivity model to decide devices and circumstances for surfacing pre-transportation request intents. Indeed, the pre-request matching system can utilize intelligent sensitivity models to identify requestor devices and provider devices most sensitive to the benefits of a pre-transportation match and surface pre-transportation request options to these devices. In this manner, the pre-request matching system can reduce unnecessary bandwidth and resources in providing notifications or pre-request options or workflows to provider devices and/or requestor devices that are unlikely to engage with a pre-transportation request match option.

The pre-request matching system can also improve user interfaces of requestor devices and provider devices. For example, the pre-request matching system improves requestor device interfaces by providing instant transportation match options that reflect transportation matches with a matched provider device (without requiring user interactions for initiating a transportation request). By utilizing an intent model and multi-requestor device interface at provider devices, the pre-request matching system can provide user interfaces that efficiently surface instant matches via user interfaces of provider devices.

The pre-request matching system also significantly improves user interfaces of provider devices by providing multi-requestor device interfaces that include significantly more transportation options, including pre-request transportation indicators together with post-request transportation indicators. By providing improved user interfaces with improved indicators for transportation matches, the pre-request matching system reduces inefficiencies and bandwidth resources associate with provider devices utilizing duplicative transportation applications and repeatedly surfacing transportation requests.

The pre-request matching system can also improve precision relative to conventional systems. Indeed, by generating pre-request transportation matches with known provider devices, the pre-request matching system can provide significantly improved information regarding an instant match between a requestor device and provider device. For instance, the pre-request matching system can provide more precise pickup times and more precise information regarding a matched provider device prior to initiating a transportation request. This leads to significantly reduced queries, changes, duplicative application sessions, or communications from requester devices that result from updates to transportation match information (e.g., changes to pick up times or surfacing of provider information for post-request transportation matches).

As indicated by the foregoing discussion, the present disclosure utilizes a variety of terms to describe the features and advantages of the pre-request matching system. For example, as used herein, the term “mobile provider device” (or provider device) refers to a computing device associated with a transportation provider or driver (e.g., a human driver or an autonomous computer system driver) that operates a transportation vehicle. For instance, a provider device refers to a mobile device such as a smartphone or tablet operated by a provider—or a device associated with an autonomous vehicle that drives along transportation routes.

As suggested above, the term “mobile requestor device” (or requestor device) refers to a computing device associated with a requestor that interacts with an application on the mobile requestor device with the intent of generating a transportation match with a mobile provider device. In one or more embodiments, a mobile requestor device receives interaction from a requestor in the form of user interactions with an application prior to submitting a transportation match. For example, a mobile requestor device can receive user interactions indicating a location of interest and/or potential drop-off location.

As used herein, the term “pre-transportation request intent” refers to an indication of purpose, intent, or objective of initiating a transportation match before submitting a transportation request to a transportation matching system. For instance, a pre-transportation request intent can reflect an intent to submit a transportation request in the future.

Moreover, as used herein, the term “multi-requestor device user interface” refers to a graphical user interface on a mobile provider device that shows multiple request indicators corresponding to multiple requestor devices. For example, a multi-requestor device user interface can include a pre-transportation request indicator for a mobile requestor device and post-transportation request indicators that correspond to additional mobile requestor devices. In one or more embodiments, the pre-request matching system can detect one or more selections or provider user interactions via the multi-requestor device user interface. For example, the pre-request matching system can receive a selection or acceptance of a pre-transportation request indicator via a multi-requestor device user interface and generate a pre-request transportation match corresponding to the mobile provider device.

As used herein, the term “pre-transportation request indicator” refers to an element, mark, or signal corresponding to a pre-transportation request intent of a mobile requestor device. For instance, a pre-transportation request indicator can include a user interface element that indicates an intent of a mobile requestor device to make a transportation request. In some implementations, a pre-transportation request indicator can include a drop-off location, rating of the mobile requestor device, and/or a modified transportation service value corresponding to a pre-request transportation match. As just indicated, in one or more cases, the pre-request matching system can generate a pre-request transportation match based on detecting a selection of a pre-transportation request indicator.

Additionally, as used herein, the term “pre-request transportation match” refers to a transportation match between a mobile requestor device and mobile provider device without receiving a transportation request from the mobile requestor device. For instance, the pre-request matching system can provide for display a pre-request transportation match on a mobile requestor device, and in response to detecting a selection of the pre-request transportation match, the pre-request matching system can generate a transportation match and dispatch the mobile provider device to a pick-up location of the mobile requestor device. Moreover, after the transportation matching system matches a requestor (or a mobile requestor device) with a provider (or a mobile provider device) in response to detecting a selection of a pre-request transportation match, the requestor can await pickup by the provider at a predetermined pick-up location. Upon pick-up, the provider transports the requestor to a drop-off location specified or indicated in pre-transportation request intent. Accordingly, a requestor may refer to (i) a person within an intent to submit a transportation request, (ii) a person who requests a request or other form of transportation but who is still waiting for pickup, (iii) a person who requests a request or other form of transportation for another person, or (iv) a person whom a transportation vehicle has picked up and who is currently riding within the transportation vehicle to a drop-off location.

Further, as used herein, the term “post-transportation request indicator” refers to an element, mark, or signal corresponding to transportation request received from a mobile requestor device. For instance, a mobile requestor device can receive interaction from a requestor in the form of a user interaction to submit a transportation request. In some cases, the pre-request matching system can surface a post-transportation request indicator for a submitted transportation request on the mobile provider device.

As used herein, the term “machine-learning,” refers to the process of constructing and implementing algorithms that can learn from and make predictions on data. For example, a machine-learning model can utilize algorithms to learn from, and make predictions on, known data by analyzing the known data to learn to generate outputs that reflect patterns and attributes of the known data. Thus, a machine-learning model makes high-level abstractions in data by generating data-driven predictions or decisions from the known input data. In various embodiments, a machine-learning model can include but is not limited to, support vector machines, linear regression, logistic regression, Bayesian networks, clustering K-nearest neighbors (KNN), K-means, random forest learning, dimensionality reduction algorithms, boosting algorithms, artificial neural networks, deep learning, etc.

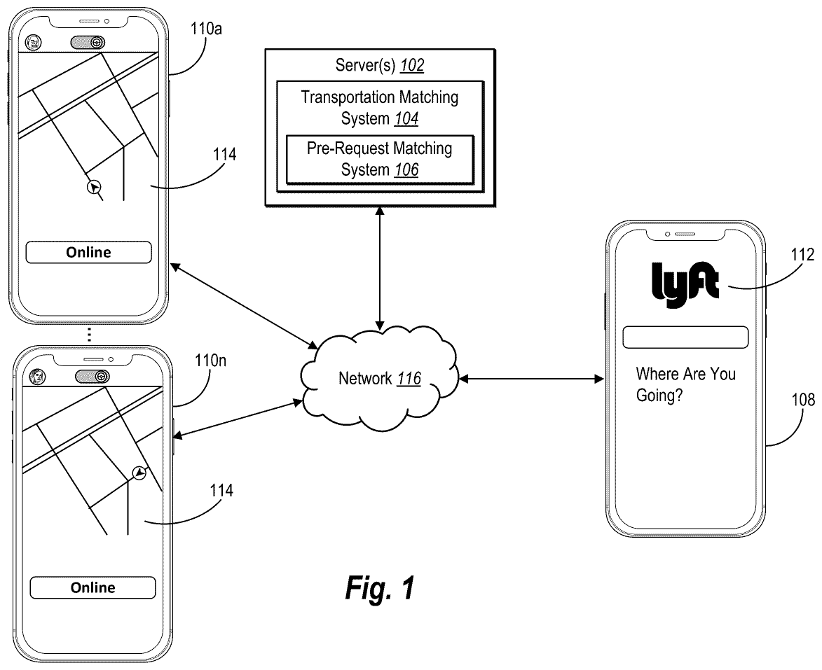

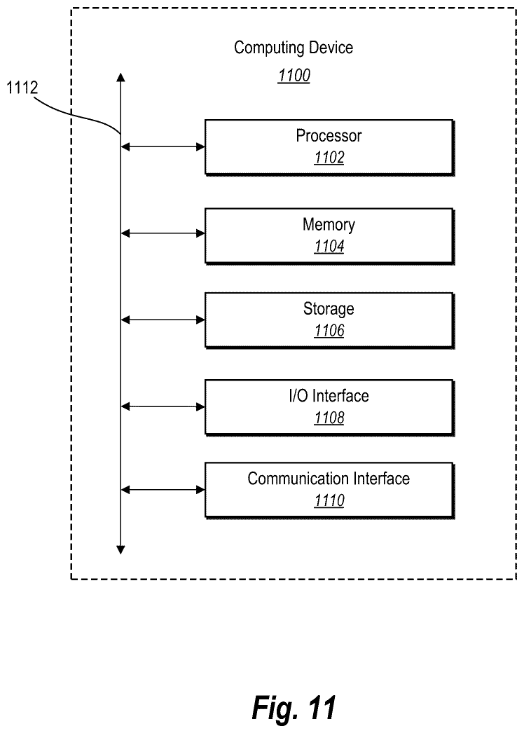

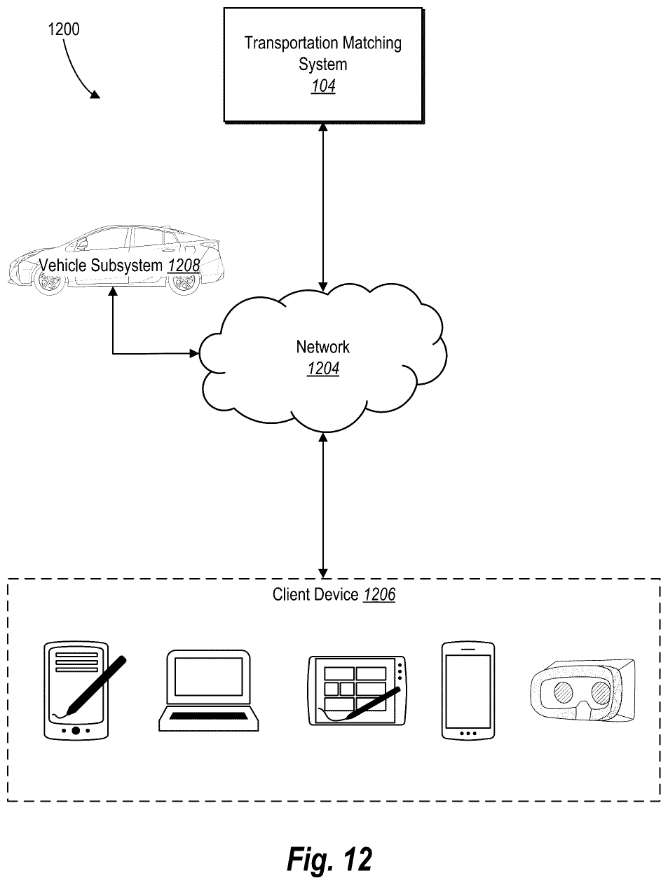

Additional detail regarding the pre-request matching system will now be provided with reference to the figures. In particular, FIG. 1 illustrates a block diagram of a system environment for implementing a pre-request matching system in accordance with one or more embodiments. As shown in FIG. 1, the environment includes server(s) 102 housing the pre-request matching system 106 as part of a transportation matching system 104. The environment of FIG. 1 further includes a provider device(s) 110a-n (including a provider application 114) and a requestor device(s) 108 (including a requestor application 112), as well as a network 116. The server(s) 102 can include one or more computing devices to implement the pre-request matching system 106. Additional detail regarding the illustrated computing devices (e.g., the server(s) 102, the provider device(s) 110a-n, the requestor device(s) 108, and/or the third-party system(s)) is provided with respect to FIG. 11-12 below.

As shown, the pre-request matching system 106 utilizes the network 116 to communicate with the provider device(s) 110a-n and the requestor device(s) 108. The network 116 may comprise any network described in relation to FIG. 11-12. For example, the pre-request matching system 106 communicates with the provider device(s) 110a-n and the requestor device(s) 108 to surface pre-transportation request indicators corresponding to the pre-transportation request intents from the requestor device(s) 108 to the provider device(s) 110a-n. Indeed, the transportation matching system 104 or the pre-request matching system 106 can detect a pre-transportation request intent from the requestor device(s) 108 and can provide a pre-transportation request indicator to various provider devices, such as a certain location (e.g., a pickup location and/or a potential drop-off location), a requestor identification (e.g., for a requestor corresponding to the requestor device(s) 108 and pre-transportation request intent). In some embodiments, per device settings, the transportation matching system 104 or the pre-request matching system 106 receives device information from various provider devices 110a-n and the requestor device(s) 108, such as location coordinates (e.g., latitude, longitude, and/or elevation), orientations or directions, motion information, and indications of user interactions with various interface elements.

To facilitate connecting pre-request transportation matches with transportation vehicles, in some embodiments, the transportation matching system 104 or the pre-request matching system 106 communicates with the provider device(s) 110a-n and other provider devices (e.g., through a provider application 114). As indicated by FIG. 1, the provider device(s) 110a-n includes the provider application 114. In many embodiments, the transportation matching system 104 or the pre-request matching system 106 communicates with the provider device(s) 110a-n through the provider application 114 to, for example, receive and provide information including location data, motion data, pre-transportation request intent and/or pre-transportation request indicator information (e.g., pickup locations and/or drop-off locations), transportation route information for navigating to one or more designated locations, and a modified transportation service value corresponding to the pre-request transportation match. Further, in some embodiments, the pre-request matching system 106 communicates with the provider device(s) 110a-n through the provider application 114 to provide a multi-requestor device user interface that includes a pre-transportation request indicator corresponding to the mobile requestor device and post-transportation request indicators corresponding to additional mobile requestor devices to the provider device(s) 110a-n and, in response to detecting a selection of the pre-transportation request indicator via the multi-requestor device user interface of the provider device(s) 110a-n, providing for display on the requestor device(s) 108, a pre-request transportation match corresponding to the provider device(s) 110a-n.

Similarly, the transportation matching system 104 or the pre-request matching system 106 communicates with the requestor device(s) 108 (e.g., through the requestor application 112) to facilitate connecting pre-transportation request intents with transportation vehicles. In many embodiments, the pre-request matching system 106 communicates with the requestor device(s) 108 through the requestor application 112 to, for example, receive and provide information including location data, motion data, pre-transportation request information (e.g., pick-up and drop-off locations), and navigation information to guide a requestor to a designated location.

As indicated above, the transportation matching system 104 or the pre-request matching system 106 can provide (and/or cause the provider device(s) 110a-n to display or render) visual elements within a graphical user interface associated with the provider application 114 and the requestor application 112. For example, the transportation matching system 104 or the pre-request matching system 106 can provide a digital map for display on the provider device(s) 110a-n that illustrates a transportation route to navigate to a designated location. The pre-request matching system 106 can also provide a pre-transportation request indicator for display on the provider device(s) 110a-n indicating a pre-transportation request intent from a requestor device(s) 108.

Moreover, as indicated, the pre-request matching system 106 provides a user interface via the requestor device(s) 108 that includes selectable options for various types of transportation requests (e.g., a standard transportation request or a pre-request transportation match).

Although FIG. 1 illustrates the environment having a particular number and arrangement of components associated with the pre-request matching system 106, in some embodiments, the environment may include more or fewer components with varying configurations. For example, in some embodiments, the transportation matching system 104 or the pre-request matching system 106 can communicate directly with the provider device(s) 110a-n and/or the requestor device(s) 108, bypassing the network 116. In these or other embodiments, the transportation matching system 104 or the pre-request matching system 106 can be housed (entirely on in part) on the provider device(s) 110a-n and/or the requestor device(s) 108. Additionally, the transportation matching system 104 or the pre-request matching system 106 can include or communicate with a database for storing information, such as various machine learning models, historical data (e.g., historical transportation matches, historical provider device patterns and/or historical requestor device sensitivities) and/or other information described herein.

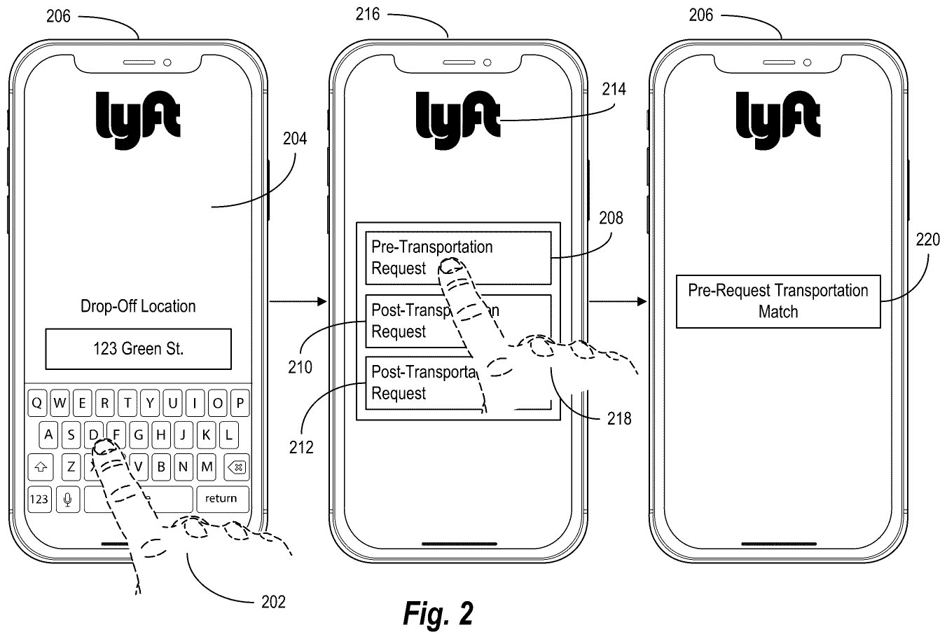

As mentioned previously, in one or more embodiments, the pre-request matching system 106 can provide for display on a mobile device a pre-request transportation match which enables an instant transportation match between a mobile requestor device and a mobile provider device without receiving a transportation request. FIG. 2 illustrates an overview of a pre-request matching system generating and providing for display a pre-request transportation match on a mobile requestor device in accordance with one or more embodiments.

As shown in FIG. 2, the pre-request matching system 106 can analyze one or more user interactions 202 with an application 204 on a mobile requestor device 206. In particular, the pre-request matching system 106 can detect one or more user selections, inputs, or navigations within the application 204. For example, the pre-request matching system 106 can detect one or more searches related to a potential drop-off location or input for the potential drop-off location within the application 204 on the mobile requestor device 206. In some embodiments, the pre-request matching system 106 can utilize an intent model to detect a pre-transportation request intent from the mobile requestor device 206 by analyzing the one or more user interactions 202. For example, the pre-request matching system 106 can utilize an intent model to analyze the one or more user interactions 202 inputting a drop-off location within a drop-off input field within the computer application and can detect the mobile requestor device 206 intending to submit a transportation request or the pre-transportation request intent from the mobile requestor device 206.

The pre-request matching system 106 can utilize a variety of intent models to determine a pre-request transportation intent from user interactions with a transportation application on a requestor device. As used herein, an intent model refers to a computer-implemented model or algorithm utilized to understand and predict an intent based on interactions with user interfaces, applications or software. The pre-request matching system 106 can utilize various types of models, including artificial intelligence, natural language processing (NLP), and machine learning to interpret user interactions and determine a pre-request intent (e.g., an intent to initiate a transportation request in the future).

In some implementations the pre-request matching system 106 utilizes intent classification models to categorize user interactions into predefined intent categories, such as “initiating a transportation request” or “checking availability. ” The pre-request matching system 106 can utilize classification models such as logistic regression, decision trees, neural networks, or transformers (e.g., BERT, GPT). The pre-request matching system 106 can utilize various machine learning models, including supervised, unsupervised, and reinforcement learning techniques, trained on large datasets to recognize patterns in how users express different intents. The pre-request matching system 106 can utilize deep learning approaches, including recurrent neural networks (RNNs), long short-term memory networks (LSTMs), and attention mechanisms, to analyze sequences and maintain context of user interactions to identify a pre-transportation request intent.

The pre-request matching system 106 can also utilize intent models that consider user behavior data, such as past interactions, preferences, and demographic information, to personalize predictions and make the intent recognition more accurate. The pre-request matching system 106 can also utilize an intent model that includes a feedback mechanisms that improves the model over time. For example, pre-request matching system 106 can utilize observed interactions with a transportation application, corrections, or clarifications to refine the model's understanding of intents over time.

As FIG. 2 further illustrates, once the pre-request matching system 106 detects the pre-transportation request intent from the mobile requestor device 206, the pre-request matching system 106 can provide for display through a multi-requestor device user interface 214 of a mobile provider device 216 a pre-transportation request indicator 208 that corresponds to the mobile requestor device 206 and reflects the pre-transportation request intent from the mobile requestor device 206. In one or more embodiments, the multi-requestor device user interface 214 can also include post-transportation request indicators 210, 212 that correspond to additional mobile requestor devices that submitted transportation requests. Indeed, the pre-request matching system 106 can differentiate between a pre-transportation request indicator 208 and post-transportation request indicators 210, 212 made by additional mobile requestor devices. Although FIG. 2 illustrates these indicators as a list of transportation request indicators, in some implementations, the transportation request indicators are displayed as a digital map with indicators positioned within the map based on pickup and/or drop-off location corresponding to a particular option.

As further shown in FIG. 2, upon detecting a selection 218 of the pre-transportation request indicator 208 by the mobile provider device 216, the pre-request matching system 106 can provide for display on the mobile requestor device 206 a pre-request transportation match 220 indicating an instant transportation match with the mobile provider device 216. Indeed, the pre-request matching system 106 can quickly and efficiently generate a pre-request transportation match without receiving a transportation request from the mobile requestor device 206. In some embodiments, based on receiving a selection of the pre-request transportation match 220 from the mobile requestor device 206, the pre-request matching system 106 can generate an instant transportation match (or transportation match) between the mobile requestor device 206 and the mobile provider device 216 and dispatch the mobile provider device 216 to a pick-up location corresponding to the instant transportation match and the mobile requestor device 206.

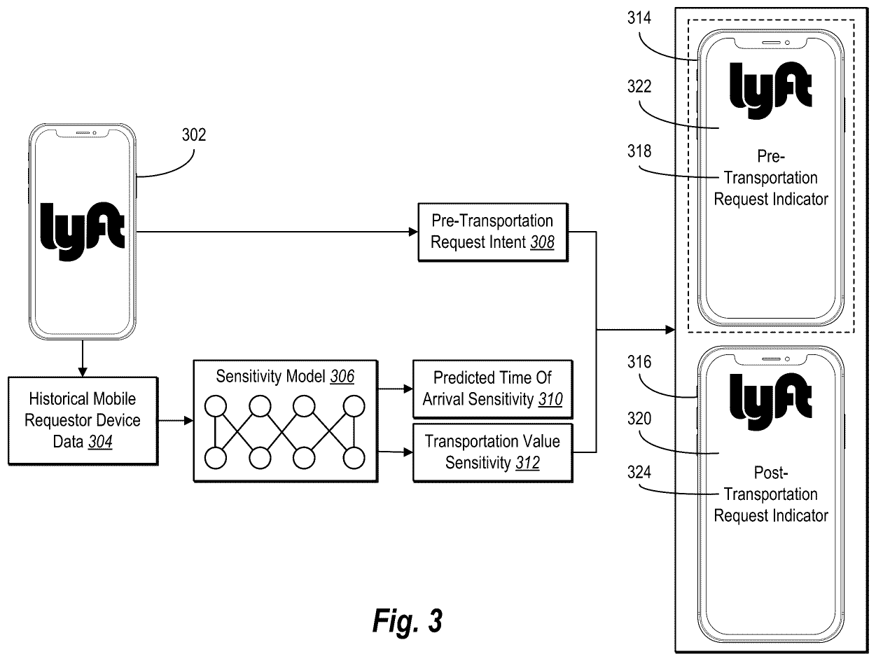

As just indicated, the pre-request matching system 106 can generate a pre-transportation request indicator based on detecting a pre-transportation request intent from a mobile provider device. In one or more cases, the pre-request matching system 106 can detect the pre-transportation request intent for a mobile requestor device and intelligently determine whether to provide for display (e.g., surface) a pre-transportation request indicator within a multi-requestor device user interface of a mobile provider device. FIG. 3 illustrates the pre-request matching system 106 utilizing a sensitivity model to generate a predicted time of arrival sensitivity and/or a transportation value sensitivity for the mobile requestor device to intelligently provide for display on a mobile provider device a pre-transportation request indicator in accordance with one or more embodiments. As mentioned above, the pre-request matching system 106 can utilize an intent model to analyze user interactions with an application to detect a pre-transportation request intent 308 for a mobile requestor device 302. In one or more embodiments, the pre-request matching system 106 can utilize the features and/or sensitivities associated with a mobile requestor device 302 to determine whether to generate and provide for display a pre-transportation request indicator 318 corresponding to the mobile requestor device 302 on a mobile provider device 314.

As shown in FIG. 3, the pre-request matching system 106 can extract historic mobile requestor device data 304 from the mobile requestor device 302. In one or more embodiments, the historic mobile requestor device data 304 can include data related to historical transportation matches of the mobile requestor device 302. For example, the historic mobile requestor device data 304 can include a logged history of drop-off locations, pick-up locations, transportation service values, tips, estimated times of arrival (or arrival times), provider device ratings, requestor device ratings, transportation match wait times, and/or routes corresponding to the mobile requestor device 302.

As FIG. 3 indicates, the pre-request matching system 106 can extract and/or determine sensitivities or priorities of the mobile requestor device 302 based on analyzing the historic mobile requestor device data 304. For example, as shown in FIG. 3, the pre-request matching system 106 can utilize a sensitivity model 306 to generate sensitivities for subjects of the historic mobile requestor device data 304. For example, the pre-request matching system 106 can utilize historical transportation matches and the sensitivity model 306 to generate sensitivities regarding aspects of utilizing a transportation service. As discussed in more detail below, the pre-request matching system 106 can utilize the sensitivity model 306 to analyze the historic mobile requestor device data 304 related to estimated times of arrival, transportation service values, etc. for the mobile requestor device 302. In one or more embodiments, the sensitivity model 306 can be a machine-learning model (e.g., decision tree, neural network or large-language model) that generates sensitivities reflecting the importance and/or priority of certain aspects of the mobile requestor device 302.

As shown in FIG. 3, the pre-request matching system 106 can utilize the sensitivity model 306 to generate a predicted time of arrival sensitivity 310 and/or a transportation value sensitivity 312. In one or more embodiments, the predicted time of arrival sensitivity 310 reflects the importance and/or weight of an earlier pick-up time and/or arrival time to a destination for the mobile requestor device 302. Indeed, in some embodiments, the arrival sensitivity 310 can reflect a trend of a mobile provider device preferring faster pick-up times and/or arrival times based on historical transportation matches. In some cases, the predicted time of arrival sensitivity 310 can be a score or amount with a higher score indicating a high prioritization and/or preference for an earlier time of arrival at a destination (e.g., drop-off location). For example, analyzing historical information of a requestor device can indicate an elevated rate of cancellations or session-ending events based on increased wait times. This can lead to a high-predicted time of arrival sensitivity and an increased likelihood of surfacing a pre-transportation request to one or more provider devices. Indeed, the pre-request matching system 106 can utilize the sensitivity model 306 to determine how the time of arrival or estimated time of arrival affects the selection of a mobile requestor device 302 for a transportation service.

As further shown in FIG. 3, the pre-request matching system 106 can generate a transportation value sensitivity 312 via the sensitivity model 306. For example, the sensitivity model 306 can analyze historic transportation service values of historical transportation matches to determine the transportation value sensitivity 312 which can reflect the importance and/or effect of the transportation service amount (e.g., cost) of a transportation service while the requestor of the mobile requestor device 302 selects a transportation service. Indeed, the pre-request matching system 106 can determine if and to what degree the transportation service value places on a selection of a transportation service by the mobile requestor device 302. In one or more embodiments, the transportation value sensitivity 312 can be a score or value reflecting a willingness by the mobile requestor device 302 to pay a higher transportation service amount for a transportation service or a preference to pay a lower transportation service amount for the transportation service. For example, analyzing historical information of a requestor device can indicated an elevated rate of cancellations or session-ending events based on increased transportation value. This can indicate a higher transportation value sensitivity and a decreased likelihood of surfacing a pre-transportation request to one or more provider devices (e.g., because the increased transportation value associated with an instant match will not be accepted by the requestor device).

In one or more embodiments, the pre-request matching system 106 can utilize the sensitivity model 306 to determine the predicted time of arrival sensitivity 310 and/or the transportation value sensitivity 312 for different time periods or events. In particular, the pre-request matching system 106 can analyze other features associated with a pre-request transportation intent and generate the transportation value sensitivity 312 corresponding to those features. For example, the pre-request matching system 106 can determine that the mobile requestor device 302 is located at the airport, and based on historic transportation service values associated with transportation services from the airport, the sensitivity model 306 can generate a higher transportation value sensitivity 312 for the mobile requestor device 302 because the historic transportation service values indicate a preference of paying a higher transportation service value while looking for a transportation service for travelling from the airport. Alternatively, the mobile requestor device 302 can have a lower transportation value sensitivity 312 reflecting the preference of a lower transportation service value while the mobile requestor device 302 travels to a restaurant or event.

As just discussed, the pre-request matching system 106 can generate the predicted time of arrival sensitivity 310 and/or transportation value sensitivity 312 for a mobile device. As further shown in FIG. 3, the pre-request matching system 106 can determine whether to generate a pre-transportation request indicator 318 based on the pre-transportation request intent 308, arrival sensitivity 310, and/or transportation value sensitivity 312. For example, the pre-request matching system 106 can detect the pre-transportation request intent 308 and based on the predicted time of arrival sensitivity 310 and/or the transportation value sensitivity 312, can determine a likelihood of the mobile requestor device 302 accepting or selecting a pre-request transportation match. For example, the pre-request matching system 106 can determine that the mobile requestor device 302 with a high predicted time of arrival sensitivity 310 (e.g., preference for an earlier arrival time) and/or a low transportation value sensitivity 312 (e.g., willingness to pay a higher transportation service value) is a good candidate for the pre-request transportation match and thus, the pre-request matching system 106 can provide the pre-transportation request indicator 318 within a multi-requestor device user interface 322 of the mobile provider device 314.

Alternatively, in some cases, the pre-request matching system 106 can determine based on the predicted time of arrival sensitivity 310 and/or the transportation value sensitivity 312 to not include the pre-transportation request indicator 318 within a multi-requestor device user interface 324 of a mobile provider device 316. For example, based on a low predicted time of arrival sensitivity 310 and/or a high transportation value sensitivity 312 of the mobile requestor device 302, the pre-request matching system 106 can determine to provide for display only a post-transportation request indicator 320 within the multi-requestor device user interface 324 without including a pre-transportation request indicator. Indeed, the pre-request matching system 106 can determine which mobile requestor devices will or will not likely accept a pre-request transportation match with the mobile provider device 314.

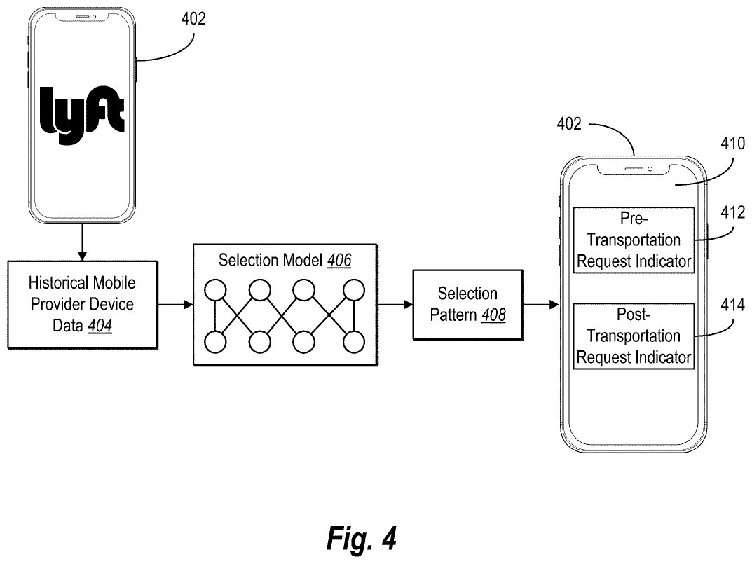

As just discussed, the pre-request matching system 106 can determine when to provide a pre-transportation request indicator corresponding to a mobile requestor device for display on a mobile provider device. In some embodiments, the pre-request matching system 106 can determine whether to provide the pre-transportation request indicator via a multi-requestor device user interface of the mobile provider device. FIG. 4 illustrates a pre-request matching system 106 providing for display via the multi-requestor device user interface, a pre-transportation request indicator based on extracting a selection pattern of transportation service requests from the mobile requestor device in accordance with one or more embodiments.

As indicated above, the pre-request matching system 106 can determine whether to generate a pre-transportation request indicator based on a pre-transportation request intent and a predicted time of arrival sensitivity and/or a transportation value sensitivity. Accordingly, the pre-request matching system 106 can determine whether to provide for display on a mobile provider device 402 a pre-transportation request indicator 412 within a multi-requestor device user interface 410. In particular, the pre-request matching system 106 can utilize historic mobile provider device data 404 associated with the mobile provider device 402 to determine a selection pattern 408 of transportation service requests for the mobile provider device 402. For example, the pre-request matching system 106 can track transportation matches and transportation services for the mobile provider device 402 and generate a log of historic mobile provider device data 404. In some embodiments, the historic mobile provider device data 404 can include a logged history of drop-off locations, pick-up locations, transportation service values, received tips, estimated times of arrival (or arrival times), provider device ratings, requestor device ratings, driving hours, driving areas, idle times, transportation match wait times, utilization, bonus program activities, acceptance rate, and/or routes.

As further shown in FIG. 4, the pre-request matching system 106 can extract for the mobile provider device 402 a selection pattern 408 of transportation service requests corresponding to mobile requestor devices. In particular, the pre-request matching system 106 can utilize the historic mobile provider device data 404 to extract, identify, and/or determine the selection pattern 408 of transportation service requests for the mobile provider device 402. In some cases, the pre-request matching system 106 can utilize a selection model 406 to extract, analyze, and/or determine the selection pattern 408 of transportation service requests of the mobile provider device 402. For example, the pre-request matching system 106 can utilize the selection model 406 to determine if the mobile provider device 402 selectively accepts (e.g., cherry-picks) transportation service requests, consistently cancels transportation matches, takes a long or short amount of time to accept a transportation request, and/or accepts transportation requests based on transportation service value, drop-off locations, pick-up locations, etc. Indeed, the pre-request matching system 106 can utilize the selection model 406 to determine one or more selection patterns reflecting why and/or how the mobile provider device 402 accepts, declines, and/or cancels a transportation service request (or transportation match). For example, the pre-request matching system 106 can utilize the selection model 406 to extract the average acceptance rate of transportation requests associated with the mobile provider device 402. In some cases, the pre-request matching system 106 can extract a selection pattern indicating that the mobile provider device 402 only selects transportation requests if they exceed a certain transportation service value or mobile requestor device rating. Moreover, in one or more embodiments, the pre-request matching system 106 can utilize the selection model 406 to extract and/or determine how transportation service values, drop-off locations, pick-up locations, etc. affect the selection pattern 408 of transportation service requests of the mobile provider device 402. In some embodiments, the pre-request matching system 106 can utilize the selection model 406 to extract the selection pattern 408 for the entire history or activity of the mobile provider device 402 or extract the selection pattern 408 over a shorter and more recent timeline. For example, the pre-request matching system 106 can utilize the historic mobile provider device data 404 of the mobile provider device 402 over the last two-weeks to determine a more recent selection pattern 408.

In some embodiments, the pre-request matching system 106 can determine and/or extract one or more additional selection patterns for one or more additional mobile provider devices and select a subset of mobile provider devices from the one or more additional mobile provider devices to provide the pre-transportation request indicator 412 for display along with the post-transportation request indicator 414. For example, based on the subset of the mobile provider devices having an acceptance rate of 80%, the pre-request matching system 106 can provide for display via the multi-requestor device user interface 410, the pre-transportation request indicator 412.

As further indicated in FIG. 4, the pre-request matching system 106 can provide the pre-transportation request indicator 412 for display on the multi-requestor device user interface 410 of the mobile provider device 402 based on the selection pattern 408 of transportation service requests. For example, based on the selection pattern 408 indicating an average acceptance rate of transportation service requests of 85%, the pre-request matching system 106 can provide for display via the multi-requestor device user interface 410 the pre-transportation request indicator 412. Indeed, the pre-request matching system 106 can provide the pre-transportation request indicator 412 on the multi-requestor device user interface 410 of the mobile provider device 402 if the selection pattern 408 indicates a high likelihood of selecting the pre-transportation request indicator 412.

Additionally, in one or more embodiments, the pre-request matching system 106 can provide the pre-transportation request indicator 412 for display on the multi-requestor device user interface 410 of the mobile provider device 402 based on the location of the mobile provider device 402. For example, if the pre-request matching system 106 detects a pre-transportation request intent for the mobile requestor device and determines that the mobile provider device 402 falls within a distance and/or time threshold from the location (or pick-up location) of the mobile requestor device, the pre-request matching system 106 can provide for display the pre-transportation request indicator 412 on the multi-requestor device user interface 410 of the mobile provider device 402. In some cases, the pre-request matching system 106 can provide for display the pre-transportation request indicator 412 based on how much closer or sooner the mobile provider device 402 in relation to the pick-up location of the mobile provider device compared to one or more additional mobile provider devices. For example, the pre-request matching system 106 can determine to provide for display the pre-transportation request indicator 412 on the mobile provider device 402 based on the mobile provider device 402 arriving at the pick-up location of the mobile requestor device five minutes before one or more additional mobile provider devices.

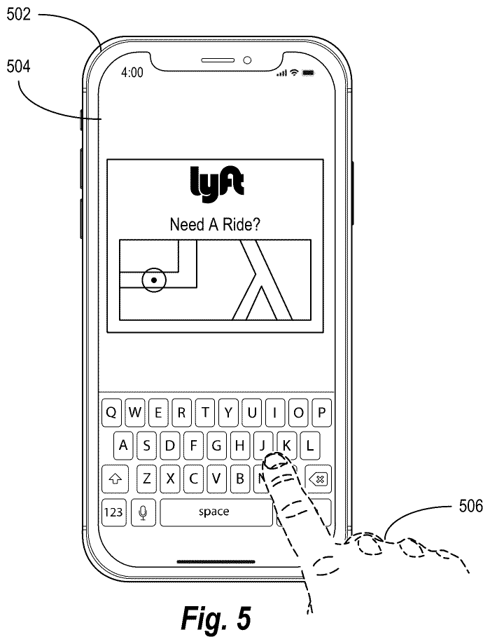

As discussed above, the pre-request matching system 106 can detect a pre-transportation request intent from a mobile requestor device based on user interactions with an application on the mobile requestor device. FIG. 5 illustrates, a pre-request matching system 106 detecting a pre-transportation request intent from a mobile requestor device in accordance with one or more embodiments. As shown in FIG. 5, the pre-request matching system 106 can receive and/or detect user interactions 506 within an application 504 of the mobile requestor device 502.

In one or more embodiments, user interactions 506 can include opening an application session, clicks, taps, holds, swipes, drags, flicks, selections, character inputs, scrolling, zoom-ins, zoom-outs with input fields, windows, and/or tabs of the application 504 or the graphical user interface of the mobile requestor device 502. In one or more embodiments, the pre-request matching system 106 can analyze the user interactions 506 with the application 504. In particular, the pre-request matching system 106 can analyze, utilizing an intent model as discussed above, whether the user interactions 506 are leading to receiving a transportation request from the mobile requestor device 502. For example, the pre-request matching system 106 can receive and/or detect textual input of a drop-off location within a drop-off input field of the application 504 from the mobile requestor device 502. In some cases, based on detecting and/or receiving the drop-off location, the pre-request matching system 106 can generate a pre-transportation request intent from the mobile requestor device 502 indicating that the mobile requestor device 502 wants a transportation service to the drop-off location.

As mentioned, in some cases, the pre-request matching system 106 can receive user interactions with the application 504. In some embodiments, the application 504 corresponds to a requestor application 112 within the transportation matching system 104. For example, the application 504 can correspond to a Lyft application. In one or more cases, the application 504 can be an application external to the transportation matching system 104. For example, the pre-request matching system 106 can detect user interactions 506 with a geographic-based application looking up a location for a business and its open hours. In some cases, the pre-request matching system 106 can detect user interactions 506 with an external transportation service system or public transit application. For example, the pre-request matching system 106 can detect an external transportation request for a destination (e.g., drop-off location) at an external transportation service application.

As indicated above, the pre-request matching system 106 can analyze user interactions 506 within the application 504. In some cases, the pre-request matching system 106 can utilize a machine-learning model, neural network, or large language model to analyze the user interactions 506 to detect the pre-transportation request intent. More specifically, the pre-request matching system 106 can determine if the mobile requestor device 502 is intending on submitting a transportation request. For example, based on receiving input for a drop-off location to a restaurant, the pre-request matching system 106 can determine that the mobile requestor device 502 intends to submit a transportation request for a transportation service to the restaurant. Indeed, the pre-request matching system 106 can detect the pre-transportation request intent from the mobile requestor device 502 based on user interactions 506 indicating a drop-off location.

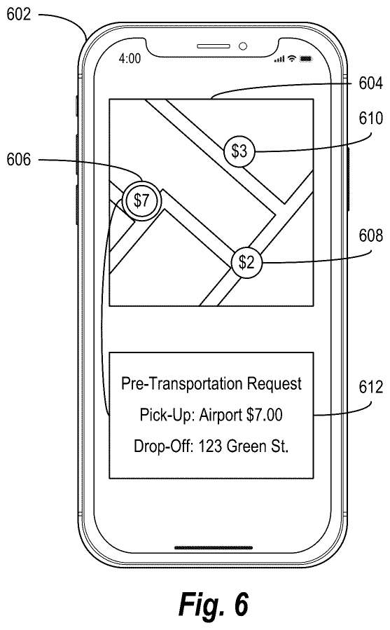

As mentioned above, once the pre-request matching system 106 detects a pre-transportation request intent, the pre-request matching system 106 can generate and provide for display a pre-transportation request indicator on a multi-requestor device user interface of a mobile provider device. FIG. 6 illustrates an exemplary multi-requestor device user interface of a mobile provider device in accordance with one or more embodiments.

As shown in FIG. 6, the pre-request matching system 106 can provide for display on a mobile provider device 602 a multi-requestor device user interface 604 that includes a pre-transportation request indicator 606 along with post-transportation request indicators 608, 610. In one or more implementations, the pre-transportation request indicator 606 can include additional information or features related to the pre-transportation request indicator 606 such as, the drop-off location, pick-up location, mobile device rating, and/or pick-up time. In some cases, the pre-request matching system 106 can determine which additional information is relevant to the mobile provider device 602 and include that information in the pre-transportation request indicator 606.

As shown in FIG. 6, in some cases, the pre-request matching system 106 can provide the pre-transportation request indicator 606 as a selectable element within an application (e.g., provider application 114) of the transportation matching system 104 while the mobile provider device 602 actively searches for a transportation match. For example, the pre-request matching system 106 can provide for display the pre-transportation request indicator 606 as a selectable element along with other transportation request matches (e.g., post-transportation request indicators 608, 610) as additional selectable elements. In one or more embodiments, the pre-request matching system 106 can distinguish the appearance of pre-transportation request indicator 606 from the post-transportation request indicators 608, 610 (e.g., different colors, different sizes, or different shapes). Alternatively, in some cases, the pre-transportation request indicator 606 can appear the same as the post-transportation request indicators 608, 610.

In some embodiments, the pre-request matching system 106 can provide for display the pre-transportation request indicator 606 as an alert within the provider application 114. For example, the pre-request matching system 106 can detect one or more user interactions with the mobile provider device 602 within the provider application 114. Based on detecting one or more user interactions with the mobile provider device 602, the pre-request matching system 106 can provide for display one or more alerts highlighting the pre-transportation request indicator 606 and features related to the pre-request transportation match. For example, the alert can communicate a modified transportation service value 612 and drop-off location corresponding to the pre-transportation match.

In some cases, the pre-request matching system 106 can provide the pre-transportation request indicator 606 as a push notification outside of the application on the mobile provider device 602. For example, as discussed above, the pre-request matching system 106 can detect a pre-transportation request intent and identify the mobile provider device 602 as a suitable candidate for a pre-request transportation match with the mobile requestor device and generate a push notification with the pre-transportation request indicator 606 highlighting the pre-request transportation match.

As just indicated, the pre-request matching system 106 can generate a modified transportation service value corresponding to a pre-request transportation match and display the modified transportation service value 612 within the multi-requestor device user interface 604. In particular, the pre-request matching system 106 can utilize a value modification model to generate the modified transportation service value 612. For instance, as indicated above, the pre-request matching system 106 can utilize the value modification model to generate the modified transportation service value 612 that weighs or increases the transportation service value of performing the pre-request transportation match by a percentage or ratio. For example, the value modification model can determine a regular transportation service value for the pre-request transportation match and increase the transportation service value by 5%.

In some cases, the value modification model can account for the location, utilization, and/or status of the mobile provider device 602 while determining the modified transportation service value 612. For example, the value modification model can generate the modified transportation service value 612 based on the mobile provider device 602 dropping-off an existing transportation match. In some cases, the value modification model can be a neural network, machine-learning model, algorithm, or large language model.

As shown in FIG. 6, the pre-transportation request indicator 606 can include a modified transportation service value 612 that corresponds to a pre-request transportation match. In some embodiments, the pre-request matching system 106 can provide for display within the multi-requestor device user interface 604, a transportation service value modification field where the pre-request matching system 106 can receive input from the mobile provider device 602 indicating a desired transportation service value for completing the pre-request transportation match. For example, in one or more embodiments, the pre-transportation request indicator 606 can include the transportation service value modification field, and the pre-request matching system 106 can receive the desired transportation service value. To further illustrate, the pre-request matching system 106 can provide for display the pre-transportation request indicator 606 along with the transportation service value modification field and receive a desired transportation value of $8.00 from the mobile provider device 602 for completing the pre-request transportation match.

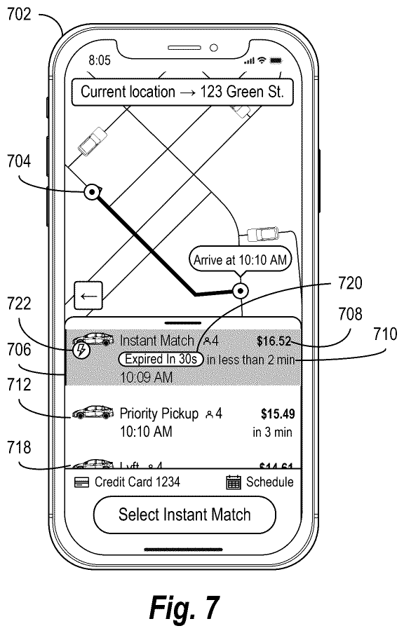

As discussed above, the pre-request matching system 106 can provide for display a pre-transportation request indicator via a multi-requestor device user interface. In one or more cases, once the pre-request matching system 106 detects a selection of the pre-transportation request indicator, the pre-request matching system 106 can provide for display a pre-request transportation match on the mobile requestor device. FIG. 7 illustrates and exemplary graphical user interface of a mobile requestor device with a pre-request transportation match in accordance with one or more embodiments. In particular, FIG. 7 shows a graphical user interface 704 on a mobile requestor device 702. As shown in FIG. 7, the graphical user interface 704 of the mobile requestor device 702 can include the pre-request transportation match 706 along with other potential transportation matches 712, 718.

As FIG. 7 illustrates, the pre-request transportation match 706 has a premium transportation service value 708 that is higher than a transportation service value associated with other potential transportation matches 712, 718 and has a faster pick-up time 710 when compared with the other potential transportation matches 712, 718. In one or more embodiments, the premium transportation service value 708 matches the modified transportation service value described in FIG. 6. In some cases, the premium transportation service value 708 differs from the modified transportation service values described in FIG. 6. For example, in some implementations, the pre-request matching system 106 can determine the premium transportation service value 708 based on (i) comparing the earlier arrival time corresponding to the pre-request transportation match 706 with a quoted arrival time of a similar post-requested transportation match, and/or (ii) the modified transportation service value corresponding to the mobile provider device. To further illustrate, the pre-request matching system 106 can determine the premium transportation service value 708 as a function of how much earlier the arrival time corresponding to the pre-request transportation match 706 in comparison to the quoted arrival time of a similar post-requested transportation match along with a function of the modified transportation service value.

In some cases, the pre-request matching system 106 can determine the premium transportation service value 708 based on other features of the provider and/or vehicle associated with the mobile provider device. For example, the pre-request matching system 106 generate the premium transportation service value 708 based on the make and model of the transportation vehicle, the ratings or badges of the provider associated with the mobile provider device, the time of day, and/or region of the pre-request transportation match 706.

As further shown in FIG. 7, the pre-request matching system 106 can include a pre-request transportation match display threshold 720. In particular, the pre-request matching system 106 can generate the pre-request transportation match display threshold 720 and determine how long to provide the pre-request transportation match 706 for display on the graphical user interface 704 of the mobile requestor device 702. For example, the pre-request transportation match display threshold 720 can range between ten seconds and two minutes. In some cases, based on satisfying or exceeding the pre-request transportation match display threshold 720, the pre-request matching system 106 can remove the pre-request transportation match 706 from the mobile requestor device 702 along with removing the corresponding pre-transportation request indicator from the multi-requestor device user interface of the mobile provider device. For example, in one or more embodiments, the pre-request transportation match display threshold 720 can be 30 seconds, thus giving the mobile requestor device 702 30 seconds to accept or select the pre-request transportation match 706. In some cases, if the pre-request matching system 106 does not detect or receive a selection of the pre-request transportation match 706 from the mobile requestor device 702, the pre-request matching system 106 can remove the pre-request transportation match 706 from the graphical user interface 704 of the mobile requestor device 702 along with the corresponding pre-transportation request indicator from the multi-requestor device user interface of the mobile provider device.

In some embodiments, the pre-request matching system 106 can provide for display the pre-request transportation match display threshold 720 after not receiving a selection of the pre-request transportation match 706 after a period of time. For example, if the pre-request matching system 106 does not receive a selection of the pre-request transportation match 706 for 15 seconds, the pre-request matching system 106 can provide for display the pre-request transportation match display threshold 720 indicating that the pre-request transportation match 706 (or instant match) will go away in 30 seconds. In some cases, the pre-request matching system 106 can generate a personalized pre-request transportation match display threshold for a specific mobile requestor device. Indeed, the pre-request matching system 106 can generate an ephemeral pre-request transportation match for an instant transportation match that has a faster time of arrival when compared to other transportation matches.

Moreover, in some cases, the pre-request transportation match 706 can also include additional information and/or data about the vehicle, provider, ratings, badges, etc. associated with the mobile provider device. For example, the pre-request transportation match 706 can include badges about the provider associated with the mobile provider device indicating that the provider is a great conversationalist, has a high tenure with the transportation matching system 104, or completed 500 transportation services. In some cases, the pre-request matching system 106 can determine which information is relevant and/or important to the mobile requestor device 702 and include that personalized information within the pre-request transportation match 706. For example, based on historic transportation matches of the mobile requestor device 702, the pre-request matching system 106 can determine features that are relevant to the mobile requestor device 702, and include those relevant features in the pre-request transportation match 706. As mentioned above, providing this information to a user interface of a requestor device can significantly improve the user interface and reduce bandwidth as requestor devices can display accurate information regarding the provider and the transportation service before a requestor device has initiated a transportation request.

Moreover, in some cases, the pre-request matching system 106 can reflect a pre-request transportation match 706 via an instant match badge 722. In some cases, the instant match badge 722 can indicate that the transportation service corresponds to the pre-request transportation match 706. Moreover, in one or more embodiments, the pre-request matching system 106 can provide for display the pre-request transportation match 706 as an alert within the requestor application 112 of the transportation matching system 104 on the graphical user interface 704 of the mobile requestor device 702. In some cases, the pre-request matching system 106 can provide the pre-request transportation match 706 as a push notification outside of the application on the mobile requestor device 702. For example, based on (i) detecting a pre-transportation request intent from the mobile requestor device 702 based on analyzing user interactions with an external transportation service application, and (ii) receiving a selection of a pre-transportation request indicator 208 from the mobile requestor device, the pre-request matching system 106 can push a notification to the graphical user interface 704 of the mobile requestor device 702 indicating an instant match (e.g., pre-request transportation match 706) with the mobile provider device within the transportation matching system 104.

Additionally, in one or more embodiments, the pre-request matching system 106 can provide for display a pre-transportation request indicator across multiple mobile provider devices. Accordingly, the pre-request matching system 106 can receive multiple selections of the pre-transportation request indicator from multiple mobile provider devices. For example, the pre-request matching system 106 can detect an additional selection of the pre-transportation request indicator via an additional multi-requestor device user interface of and additional mobile provider device. In one or more embodiments, upon detecting the additional selection, the pre-request matching system 106 can provide for display on the mobile requestor device 702 an additional pre-request transportation match corresponding to the additional mobile provider device. In some cases, the pre-request matching system 106 can receive a selection of the additional pre-request transportation match and in response, the pre-request matching system 106 can remove the pre-transportation request indicator from the multi-requestor device user interface of the mobile provider device while dispatching the additional mobile provider device to a pick-up location corresponding to the pre-transportation request indicator. Alternatively, if the pre-request matching system 106 detects multiple selections of the pre-transportation request indicator from multiple mobile provider devices, the pre-request matching system 106 can generate the pre-request transportation match 706 that corresponds to selection of the mobile provider device that the pre-request matching system 106 detected or received first.

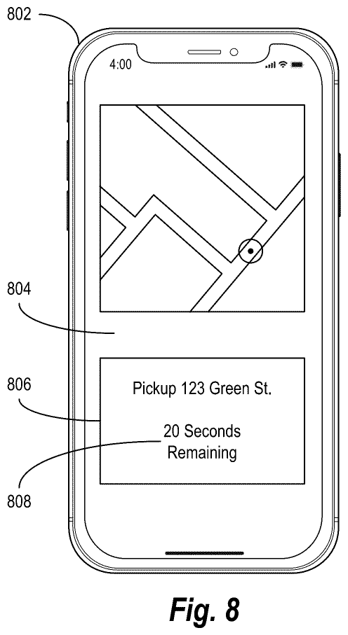

As indicated above, in some cases, once the pre-request matching system 106 receives a selection of a pre-transportation request indicator from the mobile provider device and provides for display the pre-request transportation match on the mobile requestor device, the pre-request matching system 106 can include the pre-request transportation match display threshold (e.g., within the multi-requestor device user interface or a different user interface) while the mobile provider device waits for confirmation of the pre-request transportation match from the pre-request matching system 106. FIG. 8 illustrates a pre-request matching system 106 providing a pre-request transportation match display threshold within a user interface of the mobile provider device in accordance with one or more embodiments.

As shown in FIG. 8, the pre-request matching system 106 can provide for display within the multi-requestor device user interface 804, a pre-transportation request indicator 806 with a pre-request transportation match display threshold 808. Indeed, the pre-request matching system 106 can communicate with the mobile provider device 802 as to if and when the pre-request matching system 106 detects a selection of the pre-request transportation match from the mobile requestor device. In one or more embodiments, if the pre-request matching system 106 does not detect a selection of the pre-request transportation match from the mobile requestor device within the pre-request transportation match display threshold 808, the pre-request matching system 106 will remove the pre-request transportation match display threshold 808 from display within the multi-requestor device user interface 804. Moreover, once the pre-request matching system 106 detects a selection of the pre-request transportation match from the mobile requestor device, the pre-request matching system 106 can dispatch the mobile provider device 802 to a pick-up location of the mobile requestor device.

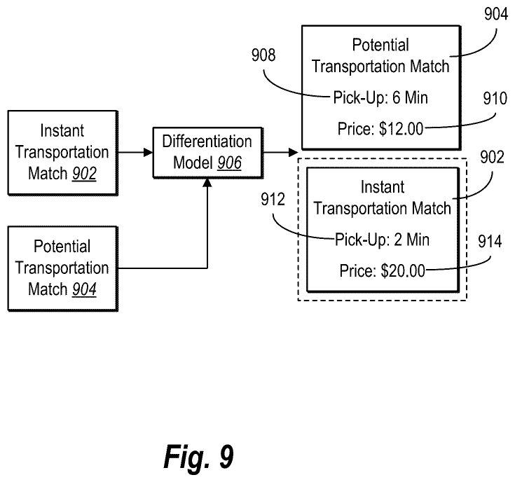

As discussed above, the pre-request matching system 106 can generate a pre-request transportation match between a mobile requestor device and mobile provider device. In some cases, the pre-request matching system 106 can differentiate the pre-request transportation match from other transportation matches to highlight the differences and/or benefits of receiving a selection of the pre-request transportation match from the mobile requestor device. FIG. 9 illustrates the pre-request matching system utilizing a differentiation model to differentiate between a pre-request transportation match and future and/or potential transportation matches in accordance with one or more embodiments.

As shown in FIG. 9, the pre-request matching system 106 can generate a pre-request transportation match 902 and a potential transportation match 904. In particular, the pre-request matching system 106 generates the potential transportation match 904 based on utilizing a transportation service algorithm that analyzes transportation service requests and available mobile provider devices. In some embodiments, based on the output of the transportation service algorithm, features of the pre-request transportation match 902 can match features of the potential transportation match 904. For example, in one or more cases, based on the number of transportation service requests, number of available mobile provider devices, and/or number of transportation service requests (or intents) from mobile requestor devices, the quoted pick-up time (or arrival time) of the potential transportation match 904 can match the arrival time of the pre-request transportation match 902 even though the transportation service value 910 of the potential transportation match 904 is lower than the premium transportation service value 914 of the pre-request transportation match 902. In such instances, the pre-request matching system 106 can utilize a differentiation model 906 to set the pre-request transportation match 902 apart from the potential transportation match 904. For example, the pre-request matching system 106 can utilize the differentiation model 906 to extend or push-back the quoted pick-up time of the potential transportation match 904 from two minutes to a differentiated pick-up time 908 of six minutes because the quoted pick-up time matched the pick-up time 912 of the pre-request transportation match 902. In some cases, the differentiation model 906 can be a neural network, machine learning model, or large language model that can determine how to modify the quoted pick-up time of the potential transportation match 904.

As previously discussed, the pre-request matching system 106 can detect a selection of a pre-request transportation match from a mobile requestor device. In some embodiments, the pre-request matching system 106 does not detect and/or receive a selection of the pre-request transportation match and removes the pre-request transportation match from a graphical user interface of a mobile requestor device. In one or more implementations, if the pre-request matching system 106 detects a rejection (or a satisfaction of a pre-request transportation match display threshold) of the pre-request transportation match, the pre-request matching system 106 can utilize the differentiation model to differentiate between the pre-request transportation match and one or more potential (or future) transportation matches.

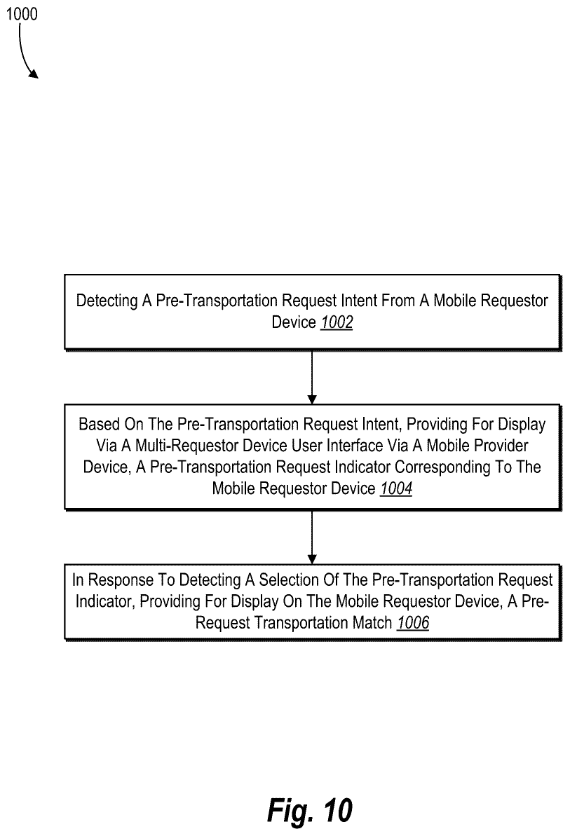

FIGS. 1-9 the corresponding text, and the examples provide a number of different systems, methods, and non-transitory computer readable media for detecting a pre-transportation request intent from a mobile device, providing for display via a multi-requestor device user interface, a pre-transportation request indicator corresponding to the mobile requestor device and the pre-transportation request intent, and in response to detecting a selection of the pre-transportation request indicator, providing for display on the mobile requestor device, a pre-request transportation match. In addition to the foregoing, embodiments can also be described in terms of flowcharts comprising acts for accomplishing a particular result. For example, FIG. 10 illustrates a flowchart of an example sequence of acts in accordance with one or more embodiments.

While FIG. 10 illustrates acts according to some embodiments, alternative embodiments may omit, add to, reorder, and/or modify any of the acts shown in FIG. 10. The acts of FIG. 10 can be performed as part of a method. Alternatively, a non-transitory computer readable medium can comprise instructions, that when executed by one or more processors, cause a computing device to perform the acts of FIG. 10. In still further embodiments, a system can perform the acts of FIG. 10. Additionally, the acts described herein may be repeated or performed in parallel with one another or in parallel with different instances of the same or other similar acts.

FIG. 10 illustrates an example series of acts 1000 for generating a pre-request transportation match between a mobile requestor device and a mobile provider device. As shown, the series of acts 1000 includes an act 1002 of detecting a pre-transportation request intent from a mobile requestor device, an act 1004 of based on the pre-transportation request intent, providing for display via a multi-requestor device user interface via a mobile provider device, a pre-transportation request indicator corresponding to the mobile requestor device, and an act 1006 of in response to detecting a selection of the pre-transportation request indicator, providing for display on the mobile requestor device, a pre-request transportation match.

For example, in one or more implementations, the act 1002 of the series of acts 1000 includes detecting, by analyzing user interactions with an application of a mobile requestor device, a pre-transportation request intent from the mobile requestor device. In some cases, the act 1004 of the series of acts 1000 includes based on detecting the pre-transportation request intent, providing for display via a multi-requestor device user interface of a mobile provider device, a pre-transportation request indicator corresponding to the mobile requestor device and post-transportation request indicators corresponding to additional mobile requestor devices. Additionally, in one or more embodiments, the act 1006 of the series of acts 1000 includes in response to detecting a selection of the pre-transportation request indicator via the multi-requestor device user interface of the mobile provider device, providing for display on the mobile requestor device, a pre-request transportation match corresponding to the mobile provider device.

In one or more implementations, the series of acts 1000 further includes generating, utilizing a sensitivity model, at least one of a predicted time of arrival sensitivity or a transportation value sensitivity for the mobile requestor device based on historical transportation matches corresponding to the mobile requestor device. Additionally, in some cases, the series of acts 1000 further includes based on the pre-transportation request intent and at least one of the predicted time of arrival sensitivity or the transportation value sensitivity, providing the pre-transportation request indicator for display via the multi-requestor device user interface of the mobile provider device.

Moreover, in one or more implementations, the series of acts 1000 includes extracting for the mobile provider device, a selection pattern of transportation service requests corresponding to mobile requestor devices. In one or more embodiments, the series of acts 1000 includes based on the selection pattern, providing for display via the multi-requestor device user interface, the pre-transportation request indicator corresponding to the mobile requestor device.

Also, in one or more implementations, the series of acts 1000 includes generating a pre-request transportation match display threshold corresponding to the pre-request transportation match. Further, in some implementations, the series of acts 1000 includes based on satisfying the pre-request transportation match display threshold, removing the pre-request transportation match from the mobile requestor device and the pre-transportation request indicator from the multi-requestor device user interface of the mobile provider device. In one or more embodiments, the series of acts 1000 includes providing, for display, the pre-request transportation match display threshold via the mobile provider device.

In some cases, the series of acts 1000 can include generating, via a value modification model, a modified transportation service value corresponding to the pre-request transportation match. Additionally, in one or more implementations, the series of acts 1000 includes providing for display via the multi-requestor device user interface of the mobile provider device, the modified transportation service value.

Moreover, in one or more embodiments, the series of acts 1000 includes detecting an additional selection of the pre-transportation request indicator via an additional multi-requestor device user interface of an additional mobile provider device. Furthermore, in one or more implementations, the series of acts 1000 includes in response to detecting the additional selection of the pre-transportation request indicator of the additional mobile provider device, providing for display on the mobile requestor device, an additional pre-request transportation match corresponding to the additional mobile provider device. In some implementations, the series of acts 1000 includes in response to detecting a selection of the additional pre-request transportation match, removing the pre-transportation request indicator from the multi-requestor device user interface of the mobile provider device and dispatching the additional mobile provider device to a pick-up location corresponding to the pre-transportation request indicator

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 11 illustrates, in block diagram form, an exemplary computing device 1100 (e.g., the provider device(s) 110a-n, the requestor device(s) 108, or the server(s) 102) that may be configured to perform one or more of the processes described above. One will appreciate that the pre-request matching system 106 can comprise implementations of the computing device 1100, including, but not limited to, the provider device(s) 110a-n and/or the server(s) 102. As shown by FIG. 11, the computing device can comprise a processor 1102, memory 1104, a storage device 1106, an I/O interface 1108, and a communication interface 1110. In certain embodiments, the computing device 1100 can include fewer or more components than those shown in FIG. 11. Components of computing device 1100 shown in FIG. 11 will now be described in additional detail.

In particular embodiments, processor(s) 1102 includes hardware for executing instructions, such as those making up a computer program. As an example, and not by way of limitation, to execute instructions, processor(s) 1102 may retrieve (or fetch) the instructions from an internal register, an internal cache, memory 1104, or a storage device 1106 and decode and execute them.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 1104 may be internal or distributed memory.

The computing device 1100 includes a storage device 1106 includes storage for storing data or instructions. As an example, and not by way of limitation, storage device 1106 can comprise a non-transitory storage medium described above. The storage device 1106 may include a hard disk drive (“HDD”), flash memory, a Universal Serial Bus (“USB”) drive or a combination of these or other storage devices.

The computing device 1100 also includes one or more input or output interface 1108 (or “I/O interface 1108”), which are provided to allow a user (e.g., requestor or provider) to provide input to (such as user strokes), receive output from, and otherwise transfer data to and from the computing device 1100. The I/O interface 1108 may include a mouse, keypad or a keyboard, a touch screen, camera, optical scanner, network interface, modem, other known I/O devices or a combination of such I/O interface 1108. The touch screen may be activated with a stylus or a finger.

The I/O interface 1108 may include one or more devices for presenting output to a user, including, but not limited to, a graphics engine, a display (e.g., a display screen), one or more output providers (e.g., display providers), one or more audio speakers, and one or more audio providers. In certain embodiments, interface 1108 is configured to provide graphical data to a display for presentation to a user. The graphical data may be representative of one or more graphical user interfaces and/or any other graphical content as may serve a particular implementation.

The computing device 1100 can further include a communication interface 1110. The communication interface 1110 can include hardware, software, or both. The communication interface 1110 can provide one or more interfaces for communication (such as, for example, packet-based communication) between the computing device and one or more other computing devices 1100 or one or more networks. As an example, and not by way of limitation, communication interface 1110 may include a network interface controller (“NIC”) or network adapter for communicating with an Ethernet or other wire-based network or a wireless NIC (“WNIC”) or wireless adapter for communicating with a wireless network, such as a WI-FI. The computing device 1100 can further include a bus 1112. The bus 1112 can comprise hardware, software, or both that connects components of computing device 1100 to each other.

FIG. 12 illustrates an example network environment 1200 of the transportation matching system 104. The network environment 1200 includes a client device 1206 (e.g., the provider device(s) 110a-n or the requestor device(s) 108), a transportation matching system 104, and a vehicle subsystem 1208 connected to each other by a network 1204. Although FIG. 12 illustrates a particular arrangement of the client device 1206, the transportation matching system 104, the vehicle subsystem 1208, and the network 1204, this disclosure contemplates any suitable arrangement of client device 1206, the transportation matching system 104, the vehicle subsystem 1208, and the network 1204. As an example, and not by way of limitation, two or more of client device 1206, the transportation matching system 104, and the vehicle subsystem 1208 communicate directly, bypassing network 1204. As another example, two or more of client device 1206, the transportation matching system 104, and the vehicle subsystem 1208 may be physically or logically co-located with each other in whole or in part.

Moreover, although FIG. 12 illustrates a particular number of client devices 1206, transportation matching systems 104, vehicle subsystems 1208, and networks 1204, this disclosure contemplates any suitable number of client devices 1206, transportation matching system 104, vehicle subsystems 1208, and networks 1204. As an example, and not by way of limitation, network environment 1200 may include multiple client devices 1206, transportation matching systems 104, vehicle subsystems 1208, and/or networks 1204.

This disclosure contemplates any suitable network 1204. As an example, and not by way of limitation, one or more portions of network 1204 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1204 may include one or more networks 1204.

Links may connect client device 1206, pre-request matching system 106, and vehicle subsystem 1208 to network 1204 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1200. One or more first links may differ in one or more respects from one or more second links.

In particular embodiments, the client device 1206 may be an electronic device including hardware, software, or embedded logic components or a combination of two or more such components and capable of carrying out the appropriate functionalities implemented or supported by client device 1206. As an example, and not by way of limitation, a client device 1206 may include any of the computing devices discussed above in relation to FIG. 11. A client device 1206 may enable a network user at the client device 1206 to access network 1204. A client device 1206 may enable its user to communicate with other users at other client devices 1206.

In particular embodiments, the client device 1206 may include a requestor application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 1206 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 1206 one or more Hyper Text Markup Language (“HTML”) files responsive to the HTTP request. The client device 1206 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, transportation matching system 104 may be a network-addressable computing system that can host a transportation matching network. The transportation matching system 104 may generate, store, receive, and send data, such as, for example, user-profile data, concept-profile data, text data, transportation request data, GPS location data, provider data, requestor data, vehicle data, or other suitable data related to the transportation matching network. This may include authenticating the identity of providers and/or vehicles who are authorized to provide transportation services through the transportation matching system 104. In addition, the transportation matching system 104 may manage identities of service requestors such as users/requestors. In particular, the transportation matching system 104 may maintain requestor data such as driving/riding histories, personal data, or other user data in addition to navigation and/or traffic management services or other location services (e.g., GPS services).

In particular embodiments, the transportation matching system 104 may manage transportation matching services to connect a user/requestor with a vehicle and/or provider. By managing the transportation matching services, the transportation matching system 104 can manage the distribution and allocation of resources from vehicle systems and user resources such as GPS location and availability indicators, as described herein.

The transportation matching system 104 may be accessed by the other components of network environment 1200 either directly or via network 1204. In particular embodiments, the transportation matching system 104 may include one or more servers. Each server may be a unitary server or a distributed server spanning multiple computers or multiple data centers. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the transportation matching system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1206, or a transportation matching system 104 to manage, retrieve, modify, add, or delete, the information stored in data store.

In particular embodiments, the transportation matching system 104 may provide users with the ability to take actions on various types of items or objects, supported by the transportation matching system 104. As an example, and not by way of limitation, the items and objects may include transportation matching networks to which users of the transportation matching system 104 may belong, vehicles that users may request, location designators, computer-based applications that a user may use, transactions that allow users to buy or sell items via the service, interactions with advertisements that a user may perform, or other suitable items or objects. A user may interact with anything that is capable of being represented in the transportation matching system 104 or by an external system of a third-party system, which is separate from transportation matching system 104 and coupled to the transportation matching system 104 via a network 1204.

In particular embodiments, the transportation matching system 104 may be capable of linking a variety of entities. As an example, and not by way of limitation, the transportation matching system 104 may enable users to interact with each other or other entities, or to allow users to interact with these entities through an application programming interfaces (“API”) or other communication channels.

In particular embodiments, the transportation matching system 104 may include a variety of servers, sub-systems, programs, modules, logs, and data stores. In particular embodiments, the transportation matching system 104 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile (e.g., provider profile or requestor profile) store, connection store, third-party content store, or location store. The transportation matching system 104 may also include suitable components such as network interfaces, security mechanisms, load balancers, failover servers, management-and-network-operations consoles, other suitable components, or any suitable combination thereof. In particular embodiments, the transportation matching system 104 may include one or more user-profile stores for storing user profiles for transportation providers and/or transportation requestors. A user profile may include, for example, biographic information, demographic information, behavioral information, social information, or other types of descriptive information, such as interests, affinities, or location.

The web server may include a mail server or other messaging functionality for receiving and routing messages between the transportation matching system 104 and one or more client devices 1206. An action logger may be used to receive communications from a web server about a user's actions on or off the transportation matching system 104. In conjunction with the action log, a third-party-content-object log may be maintained of user exposures to third-party-content objects. A notification controller may provide information regarding content objects to a client device 1206. Information may be pushed to a client device 1206 as notifications, or information may be pulled from client device 1206 responsive to a request received from client device 1206. Authorization servers may be used to enforce one or more privacy settings of the users of the transportation matching system 104. A privacy setting of a user determines how particular information associated with a user can be shared. The authorization server may allow users to opt in to or opt out of having their actions logged by the transportation matching system 104 or shared with other systems, such as, for example, by setting appropriate privacy settings. Third-party-content-object stores may be used to store content objects received from third parties. Location stores may be used for storing location information received from client devices 1206 associated with users.

In addition, the vehicle subsystem 1208 can include a human-operated vehicle or an autonomous vehicle. A provider of a human-operated vehicle can perform maneuvers to pick up, transport, and drop off one or more requestors according to the embodiments described herein. In certain embodiments, the vehicle subsystem 1208 can include an autonomous vehicle—e.g., a vehicle that does not require a human operator. In these embodiments, the vehicle subsystem 1208 can perform maneuvers, communicate, and otherwise function without the aid of a human provider, in accordance with available technology.

In particular embodiments, the vehicle subsystem 1208 may include one or more sensors incorporated therein or associated thereto. For example, sensor(s) can be mounted on the top of the vehicle subsystem 1208 or else can be located within the interior of the vehicle subsystem 1208. In certain embodiments, the sensor(s) can be located in multiple areas at once—e.g., split up throughout the vehicle subsystem 1208 so that different components of the sensor(s) can be placed in different locations in accordance with optimal operation of the sensor(s). In these embodiments, the sensor(s) can include motion-related components such as an inertial measurement unit (“IMU”) including one or more accelerometers, one or more gyroscopes, and one or more magnetometers. The sensor(s) can additionally or alternatively include a wireless IMU (“WIMU”), one or more cameras, one or more microphones, or other sensors or data input devices capable of receiving and/or recording information relating to navigating a route to pick up, transport, and/or drop off a requestor.

In particular embodiments, the vehicle subsystem 1208 may include a communication device capable of communicating with the client device 1206 and/or the pre-request matching system 106. For example, the vehicle subsystem 1208 can include an on-board computing device communicatively linked to the network 1204 to transmit and receive data such as GPS location information, sensor-related information, requestor location information, or other relevant information.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
detecting, by analyzing user interactions with an application of a mobile requestor device, a pre-transportation request intent from the mobile requestor device;
based on detecting the pre-transportation request intent, providing for display via a multi-requestor device user interface of a mobile provider device, a pre-transportation request indicator corresponding to the mobile requestor device and post-transportation request indicators corresponding to additional mobile requestor devices; and
in response to detecting a selection of the pre-transportation request indicator via the multi-requestor device user interface of the mobile provider device, providing for display on the mobile requestor device, a pre-request transportation match corresponding to the mobile provider device.

2. The computer-implemented method of claim 1, further comprising:
generating, utilizing a sensitivity model, at least one of a predicted time of arrival sensitivity or a transportation value sensitivity for the mobile requestor device based on historical transportation matches corresponding to the mobile requestor device; and
based on the pre-transportation request intent and at least one of the predicted time of arrival sensitivity or the transportation value sensitivity, providing the pre-transportation request indicator for display via the multi-requestor device user interface of the mobile provider device.

3. The computer-implemented method of claim 1, further comprising:
extracting for the mobile provider device, a selection pattern of transportation service requests corresponding to mobile requestor devices; and
based on the selection pattern, providing for display via the multi-requestor device user interface, the pre-transportation request indicator corresponding to the mobile requestor device.

4. The computer-implemented method of claim 1, further comprising:
generating a pre-request transportation match display threshold corresponding to the pre-request transportation match; and
based on satisfying the pre-request transportation match display threshold, removing the pre-request transportation match from the mobile requestor device and the pre-transportation request indicator from the multi-requestor device user interface of the mobile provider device.

5. The computer-implemented method of claim 4, further comprising providing, for display, the pre-request transportation match display threshold via the mobile provider device.

6. The computer-implemented method of claim 1, further comprising:
generating, via a value modification model, a modified transportation service value corresponding to the pre-request transportation match; and
providing for display via the multi-requestor device user interface of the mobile provider device, the modified transportation service value.

7. The computer-implemented method of claim 1, further comprising:
detecting an additional selection of the pre-transportation request indicator via an additional multi-requestor device user interface of an additional mobile provider device;
in response to detecting the additional selection of the pre-transportation request indicator of the additional mobile provider device, providing for display on the mobile requestor device, an additional pre-request transportation match corresponding to the additional mobile provider device; and
in response to detecting a selection of the additional pre-request transportation match, removing the pre-transportation request indicator from the multi-requestor device user interface of the mobile provider device and dispatching the additional mobile provider device to a pick-up location corresponding to the pre-transportation request indicator.

8. A system comprising:
at least one processor; and
a non-transitory computer readable storage medium comprising instructions that, when executed by the at least one processor, cause the system to:
detect, by analyzing user interactions with an application of a mobile requestor device, a pre-transportation request intent from the mobile requestor device;
based on detecting the pre-transportation request intent, provide for display via a multi-requestor device user interface of a mobile provider device, a pre-transportation request indicator corresponding to the mobile requestor device and post-transportation request indicators corresponding to additional mobile requestor devices; and
in response to detecting a selection of the pre-transportation request indicator via the multi-requestor device user interface of the mobile provider device, provide for display on the mobile requestor device, a pre-request transportation match corresponding to the mobile provider device.

9. The system of claim 8, further comprising instructions that, when executed by the at least one processor, cause the system to:
generate, utilizing a sensitivity model, at least one of a predicted time of arrival sensitivity or a transportation value sensitivity for the mobile requestor device based on historical transportation matches corresponding to the mobile requestor device; and
based on the pre-transportation request intent and at least one of the predicted time of arrival sensitivity or the transportation value sensitivity, provide the pre-transportation request indicator for display via the multi-requestor device user interface of the mobile provider device.

10. The system of claim 8, further comprising instructions that, when executed by the at least one processor, cause the system to:
extract for the mobile provider device, a selection pattern of transportation service requests corresponding to mobile requestor devices; and
based on the selection pattern, provide for display via the multi-requestor device user interface, the pre-transportation request indicator corresponding to the mobile requestor device.

11. The system of claim 8, further comprising instructions that, when executed by the at least one processor, cause the system to:
generate a pre-request transportation match display threshold corresponding to the pre-request transportation match; and
based on satisfying the pre-request transportation match display threshold, remove the pre-request transportation match from the mobile requestor device and the pre-transportation request indicator from the multi-requestor device user interface of the mobile provider device.

12. The system of claim 11, further comprising instructions that, when executed by the at least one processor, cause the system to: provide, for display, the pre-request transportation match display threshold via the mobile provider device.

13. The system of claim 8, further comprising instructions that, when executed by the at least one processor, cause the system to:
generate, via a value modification model, a modified transportation service value corresponding to the pre-request transportation match; and
provide for display via the multi-requestor device user interface of the mobile provider device, the modified transportation service value.

14. The system of claim 8, further comprising instructions that, when executed by the at least one processor, cause the system to:
detect an additional selection of the pre-transportation request indicator via an additional multi-requestor device user interface of an additional mobile provider device;
in response to detecting the additional selection of the pre-transportation request indicator of the additional mobile provider device, provide for display on the mobile requestor device, an additional pre-request transportation match corresponding to the additional mobile provider device; and
in response to detecting a selection of the additional pre-request transportation match, remove the pre-transportation request indicator from the multi-requestor device user interface of the mobile provider device and dispatching the additional mobile provider device to a pick-up location corresponding to the pre-transportation request indicator.

15. A non-transitory computer readable storage medium comprising instructions that, when executed by at least one processor, cause the at least one processor to:
detect, by analyzing user interactions with an application of a mobile requestor device, a pre-transportation request intent from the mobile requestor device;
based on detecting the pre-transportation request intent, provide, for display via a multi-requestor device user interface of a mobile provider device, a pre-transportation request indicator corresponding to the mobile requestor device and post-transportation request indicators corresponding to additional mobile requestor devices; and
in response to detecting a selection of the pre-transportation request indicator via the multi-requestor device user interface of the mobile provider device, provide for display on the mobile requestor device, a pre-request transportation match corresponding to the mobile provider device.

16. The non-transitory computer readable storage medium of claim 15, further comprising instructions that, when executed by the at least one processor, cause the at least one processor to:
generate, utilizing a sensitivity model, at least one of a predicted time of arrival sensitivity or a transportation value sensitivity for the mobile requestor device based on historical transportation matches corresponding to the mobile requestor device; and
based on the pre-transportation request intent and at least one of the predicted time of arrival sensitivity or the transportation value sensitivity, provide the pre-transportation request indicator for display via the multi-requestor device user interface of the mobile provider device.

17. The non-transitory computer readable storage medium of claim 15, further comprising instructions that, when executed by the at least one processor, cause the at least one processor to:
extract for the mobile provider device, a selection pattern of transportation service requests corresponding to mobile requestor devices; and
based on the selection pattern, provide for display via the multi-requestor device user interface, the pre-transportation request indicator corresponding to the mobile requestor device.

18. The non-transitory computer readable storage medium of claim 15, further comprising instructions that, when executed by the at least one processor, cause the at least one processor to:
generate a pre-request transportation match display threshold corresponding to the pre-request transportation match; and
based on satisfying the pre-request transportation match display threshold, remove the pre-request transportation match from the mobile requestor device and the pre-transportation request indicator from the multi-requestor device user interface of the mobile provider device.

19. The non-transitory computer readable storage medium of claim 18, further comprising instructions that, when executed by the at least one processor, cause the at least one processor to: provide, for display, the pre-request transportation match display threshold via the mobile provider device.

20. The non-transitory computer readable storage medium of claim 15, further comprising instructions that, when executed by the at least one processor, cause the at least one processor to:
generate, via a value modification model, a modified transportation service value corresponding to the pre-request transportation match; and
provide for display via the multi-requestor device user interface of the mobile provider device, the modified transportation service value.
